(19) United States
(12) Patent Application Publication
(10) Pub. No.: US 2024/0320804 A1
(43) Pub. Date: Sep. 26, 2024

(54) NOISE FILTERING METHOD AND SCANNING ELECTRON MICROSCOPE (SEM) EQUIPMENT ALIGNMENT METHOD USING THE SAME

(71) Applicant: Samsung Electronics Co., Ltd., Suwon-si (KR)

(72) Inventor: Nohong Kwak, Suwon-si (KR)

(21) Appl. No.: 18/414,796

(22) Filed: Jan. 17, 2024

(30) Foreign Application Priority Data
Mar. 24, 2023 (KR) 10-2023-0039006
Apr. 24, 2023 (KR) 10-2023-0053578

(51) Int. Cl. G06T 5/70; G06T 7/00; G06T 7/33; G06T 11/00

(52) U.S. Cl. CPC G06T 5/70; G06T 7/0006; G06T 7/001; G06T 7/337; G06T 11/00; G06T 2207/10024; G06T 2207/10061; G06T 2207/20081; G06T 2207/20084; G06T 2207/30148; G06T 2207/30168; G06T 2210/32

(57) ABSTRACT

A noise filtering method includes converting a scanning electron microscope (SEM) image into a converted design image using a conversion model, converting the converted design image into a gray level co-occurrence matrix (GLCM), extracting statistical characteristics of the GLCM, and determining whether the converted design image includes noise or not based on the statistical characteristics.

### CROSS-REFERENCE TO RELATED APPLICATION

This application is based on and claims priority under 35 U.S.C. § 119 to Korean Patent Application Nos. 10-2023-0039006, filed on Mar. 24, 2023, and 10-2023-0053578, filed on Apr. 24, 2023, in the Korean Intellectual Property Office, the disclosures of which are incorporated by reference herein in their entirety.

### BACKGROUND

The inventive concept relates to a scanning electron microscope (SEM) equipment alignment method, and more particularly, to a noise filtering method.

SEM technology has been widely used to scan devices and wiring patterns on a semiconductor substrate into a SEM image by using SEM equipment and examine the differences between the SEM image and a design image. However, according to a conventional inspection method, similarity is measured between images or the same features, which have been found, are compared and aligned between images, so that there are limitations in that a shape or a vector component needs to be similar between images. Accordingly, when inspecting heterogeneous images, the comparison and alignment are difficult between heterogeneous images, and thus, the inspection on the heterogeneous images often fails. When the inspection fails, an operator has to proceed with manual comparison and alignment, which are time consuming and expensive.

### SUMMARY

The inventive concept provides a method of filtering out noise from a scanning electron microscope (SEM) image and a method of accurately aligning SEM equipment based on the filtered SEM image.

In addition, the problems to be solved by the inventive concept are not limited to the above-described problems, and other problems will be clearly understood by one of ordinary skill in the art from the following description.

According to an aspect of the inventive concept, there is provided a noise filtering method including converting a SEM image into a converted design image using a conversion model, converting the converted design image into a gray level co-occurrence matrix (GLCM), extracting statistical characteristics of the GLCM, and determining whether the converted design image includes noise or not, based on the statistical characteristics.

According to another aspect of the inventive concept, there is provided a noise filtering method including obtaining SEM images of a target to be measured by using a SEM equipment, performing a pre-processing on the SEM images and design images corresponding to the SEM images, selecting training SEM images for training among the SEM images, performing training by using the training SEM images and training design images corresponding to the training SEM images, to generate a conversion model between the SEM images and the design images, converting the SEM images into converted design images by using the conversion model, converting each converted design image into a GLCM, extracting statistical characteristics of the GLCM, and determining whether or not the converted design images include noise based on the statistical characteristics.

According to another aspect of the inventive concept, there is provided a SEM equipment alignment method including obtaining a plurality of SEM images for a target by using a SEM equipment, performing a pre-processing on the SEM images and corresponding design images, selecting training SEM images for training among the SEM images, performing training based on the training SEM images and training design images corresponding to the training SEM images, to generate a conversion model between the SEM images and the design images, converting the SEM images into converted design images by using the conversion model, converting each converted design image into a GLCM, extracting statistical characteristics of the GLCM, determining whether the converted design images include noise based on the statistical characteristics, comparing and aligning each converted design image with the corresponding design image, to extract alignment coordinate value, and determining a measurement error of the SEM equipment based on the alignment coordinate value.

### BRIEF DESCRIPTION OF THE DRAWINGS

Example embodiments will be more clearly understood from the following detailed description taken in conjunction with the accompanying drawings in which:

FIG. 1 is a flowchart schematically illustrating a scanning electron microscope (SEM) equipment alignment method according to some embodiments;

FIG. 2 is a conceptual view illustrating the SEM equipment alignment method shown in FIG. 1;

FIG. 3 is a conceptual view illustrating a process of generating a conversion model by using a generative adversarial network (GAN) algorithm in the SEM equipment alignment method shown FIG. 1;

FIG. 4 is a flowchart showing a method of filtering a converted design image in the SEM equipment alignment method in FIG. 1;

FIG. 5 is a conceptual view illustrating a quantized converted design image according to some embodiments;

FIG. 6 is a conceptual view illustrating a gray level co-occurrence matrix (GLCM) corresponding to the image shown in FIG. 5;

FIG. 7A is an SEM image that is not determined as noise according to some embodiments, and FIG. 7B is a converted design image generated by converting the SEM image in FIG. 7A;

FIG. 8A is an SEM image that is determined as noise according to some embodiments, and FIG. 8B is a converted design image generated by converting the SEM image in FIG. 8A;

FIG. 9 is a graph showing entropy distribution of a plurality of converted design images according to some embodiments; and

FIG. 10A is a block diagram showing an alignment apparatus of SEM equipment according to some embodiments, and FIG. 10B is a block diagram showing a calculation server of the alignment apparatus of the SEM equipment in FIG. 10A in more detail.

### DETAILED DESCRIPTION

Hereinafter, various embodiments of the inventive concept are described in detail with reference to the accompanying drawings. The same reference numerals denote the same elements in the drawings, and repeated descriptions of the same elements may be omitted in the interest of brevity.

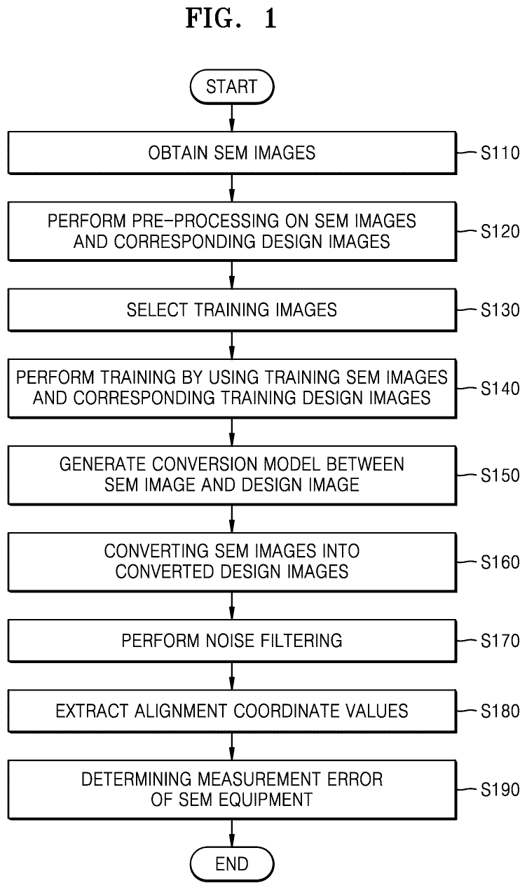

FIG. 1 is a flowchart schematically illustrating a scanning electron microscope (SEM) equipment alignment method according to some embodiments.

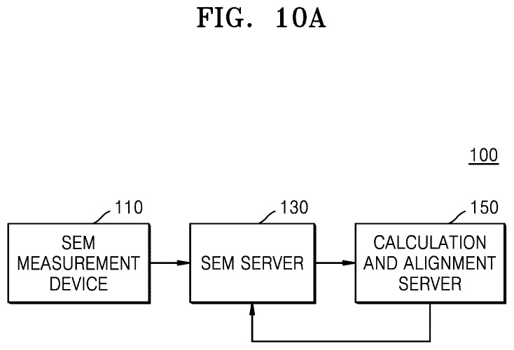

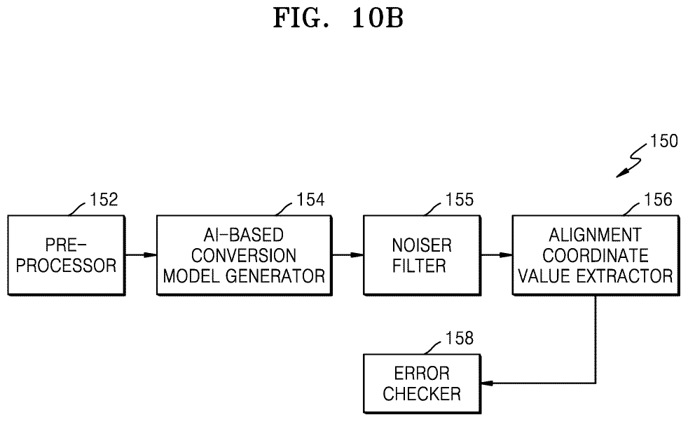

Referring to FIG. 1, a SEM equipment alignment method according to some embodiments (hereinafter, may be referred to as alignment method) may firstly obtain SEM images of devices or wiring patterns on a semiconductor substrate such as a wafer (S110). The SEM image may be obtained by the SEM measurement device 110 in FIG. 10A. For example, the SEM measurement device includes a measuring device in which electrons emitted from an electron gun are focused by lenses to generate an electron beam, a sample to be inspected is scanned by the electron beam by using a scanning coil, and a SEM image corresponding to the sample is obtained by detecting secondary electrons (SE) and back scattered electrons (BSE) that are emitted from the sample. The lenses may include magnetic lenses having electromagnets (electronic lenses) instead of optical lenses, and the resolution of the magnetic lens may be higher as the diameter of the electron beam decreases, so that the lenses may observe the sample up to hundreds of thousands of times and the SEM image may be obtained as a three-dimensional image of the sample. The SEM measurement device 110 is described in more detail with reference to FIG. 10A.

The SEM image may have a bitmap file format. For example, the SEM image may have a bitmap file format such as a bitmap (BMP), a tagged image file format (TIFF), and a joint photographic experts group (JPEG). The image file may be largely divided into the bitmap file format and a vector file format. The bitmap file format refers to an image file format in which an image is configured by a quadrangular pixel. Since each pixel of the bitmap image gives different colors, the gray level or the color difference may be accurate in the whole image, and thus, various colors may be fully shown in the image. In addition, the color may be easily changed in each pixel, and thus, the image correction and synthesis may also be easily performed. However, since the number of pixels in the image is fixed, the original pixels of the image may be lost when the image size is changed or the image is compressed, and accordingly, image quality may deteriorate when the image is excessively enlarged/reduced or continuously compressed and stored.

In contrast, the vector file format is an image file format in which an image is constructed by values of line segments connecting points, so that the vector image is expressed by lines and surfaces that are defined based on coordinate values of the points and lines and curve values of the surfaces which are obtained by mathematical calculation in an x-y coordinate system. Since the vector image is reconstructed by the mathematical calculation without using pixels, image quality may not easily deteriorate and the original image quality may be maintained without any damages to the image even when the image is sufficiently enlarged, so that the vector image may be free to the size adjustment and the curve deformation and a deformation process such as a morphing and animation may be easily performed on the vector image. However, the vector file format may be difficult to express a fine picture or gradual changes in color and have low speed when an effect is applied to the image, so that the vector image is difficult to perform natural synthesis with other images.

The devices or wiring patterns on semiconductor substrates may be formed by a photolithography process based on design images such as computer-aided design (CAD) images. The CAD image may have a file format, for example, a graphic data system (GDS) format or a GDSII format. The GDS file format may be a kind of a binary file format and include a standard database file format for data exchange in an integrated circuit (IC) or IC-layout artwork. The GDS file format may include a variety of information on a layout of a planar geometric shapes, a text label, and a hierarchical form.

Then, after obtaining the SEM images, a pre-processing may be performed on the SEM images and the corresponding design images (S120). For example, a measurement information file for the SEM images may be generated and the design images may be converted into bitmap images formatted with a bitmap file format in the pre-processing process. The measurement information file may include some information such as measured coordinate values, a field of view (FOV), a pixel size, and/or rotation, etc. Since the design image may be formatted as the GDS file format as described above, the GDS file format may be converted into a digital image file format such as a portable networks graphics (PNG) file format in the pre-processing process. The pre-processing may facilitate the comparison and alignment between the SEM image and the design image in subsequent processes.

After performing the pre-processing, training SEM images may be selected (S130). The training SEM images may be selected from among the SEM images. For example, thousands or tens of thousands of the SEM images may be obtained by the SEM equipment, and tens or hundreds of the SEM images may be selected as the training SEM images. Particularly, some of the SEM images in which the pattern and the space are clearly separated may be selected as the training SEM images so as to increase the accuracy of conversion models generated by training.

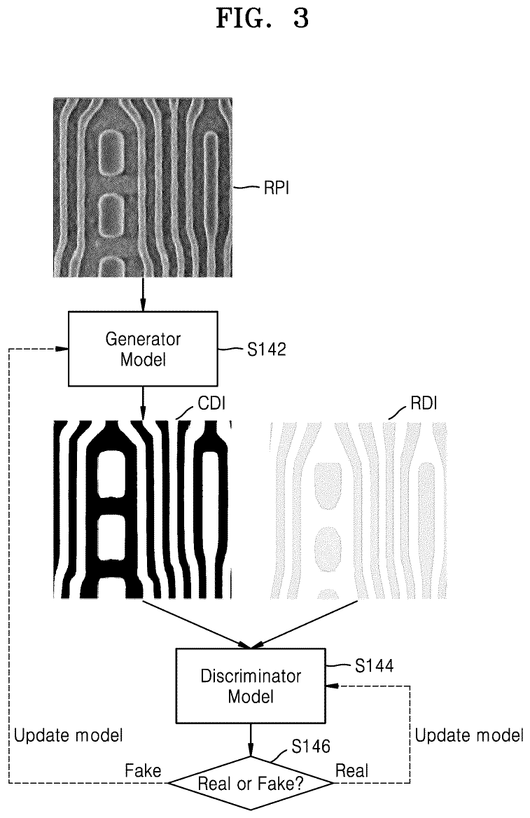

After selecting the training SEM images, the training may be performed by using the training SEM images and the corresponding training design images (S140). The training may be performed to find an optimal conversion model between the training SEM images and the corresponding training design images. That is, when a training SEM image A corresponds to a training design image B, the training may include a process of finding a conversion model for converting the training SEM image A into another SEM image B′ which is almost identical to the training design image B. The training may be performed by artificial intelligence (AI) learning algorithms such as generative adversarial network (GAN) algorithms. The training by using the GAN is described in more detail with reference to FIG. 3.

Thereafter, as a result of the training, a conversion model may be generated between the SEM image and the design image (S150). The conversion model may include an image conversion program or image conversion algorithm that converts an image a into an image 3. That is, the SEM image may be converted into another SEM image that is substantially identical to the corresponding design image by the conversion model, as described above. Hereinafter, another SEM image, which is converted from a corresponding SEM image by the conversion model, may be referred to as ‘converted design image’.

After generating the conversion model, the SEM images may be converted into converted design images by the conversion model (S160). In other words, the rest of the SEM images, which are not involved for the training, may be converted into the converted design images by the conversion model.

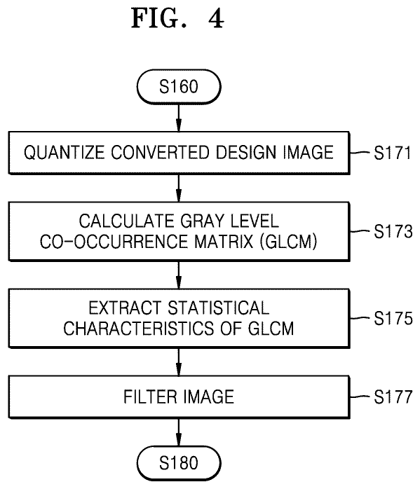

After generating the converted design images, noise filtering may be performed on the converted design images (S170). The noise may be filtered based on the converted design images. For example, the converted design images may be quantized. Then, the quantized converted design images may be converted into a gray level co-occurrence matrix (GLCM) and the statistical characteristics of the GLCM may be extracted, to thereby filter the noise from the converted design images. The processes of the noise filtering are described in detail with reference to FIGS. 4 to 9.

After filtering out the noise from the converted design images, the converted design images may be compared and aligned with the corresponding design images, to thereby extract the alignment coordinate values (S180). The alignment coordinate value may include a criterion for indicating a degree of deviation between the converted design image and the corresponding design image. For example, the converted design image may be an image corresponding to a pattern on the semiconductor substrate at the same position of the corresponding SEM image. Accordingly, the converted design image and the corresponding SEM image may have the same coordinate value. In case that no errors are in the SEM equipment, the converted design image may be accurately matched to the design image based on the correspondence between the design image and the converted design image. However, when some errors are in the SEM equipment, the pattern on a position of the semiconductor substrate is not exactly obtained as a SEM pattern corresponding to the same position in obtaining the SEM image, so that the SEM image may have errors in measurement coordinates. Accordingly, the obtained SEM image may be a deviated SEM image that is deviated or misaligned from the originally intended position, and thus, the converted design image may be a deviated converted design image that is converted from the deviated SEM image. As a result, the design image may not match the converted design image and the design image and the converted design image may deviate from each other. Therefore, it is required that the converted design image be aligned with the design image, and the alignment coordinate values may be extracted in the aligning process.

After extracting an alignment coordinate value, a measurement error of the SEM equipment may be determined based on the alignment coordinate values (S190). For example, when the alignment coordinate value is over a preset allowable value, the SEM equipment may be determined to have the measurement error, and when the alignment coordinate value is below the allowable value, the SEM equipment may be determined to be normal. When the SEM equipment has the measurement error, a SEM equipment alignment process may be performed.

According to some embodiments of the SEM equipment alignment method, the conversion model may be generated by using the AI learning algorithm, such as the GAN algorithm, and the SEM image may be converted into the converted design image by the conversion model.

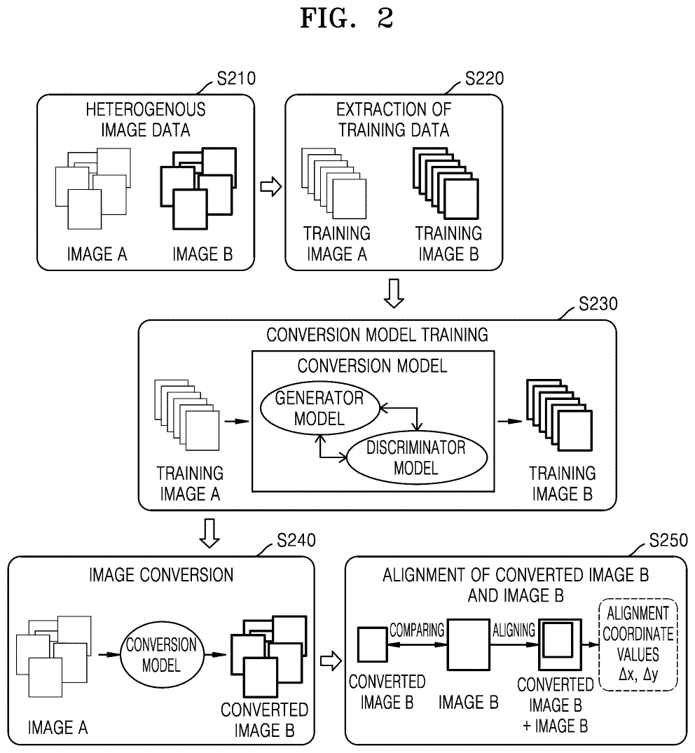

FIG. 2 is a conceptual view illustrating the SEM equipment alignment method shown in FIG. 1. The descriptions on the same elements in FIG. 1 may be briefly given or omitted in the interest of brevity.

Referring to FIG. 2, an alignment method according to some embodiments may firstly obtain heterogeneous image data (S210). Operation S210 may correspond to operation S110 of obtaining the SEM images and operation S120 of performing the pre-processing shown in FIG. 1. For example, ‘image A’ in FIG. 2 may correspond to the SEM images and ‘image B’ may correspond to the design images. The SEM images and the design images may be heterogeneous image data having different file formats. For example, the SEM images may have a BMP file format, and the design images may have a GDS file format. In addition, the image A and the image B may be images on which the pre-processing is performed. Thus, the image B may have an image file format that is changed from the GDS file format, for example, the PNG file format.

Hereinafter, training data may be extracted (S220). Operation S220 may correspond to operation S130 of selecting the training SEM images shown in FIG. 1. For example, a training image A may correspond to the training SEM images selected from among a plurality of SEM images. In addition, in operation S220, training images B may be extracted, and the training images B correspond to training design images selected from among a plurality of design images corresponding to the training SEM images. Thus, the training design images may be selected in correspondence to the training SEM images, respectively.

Then, the training for generating the conversion model may be performed (S230). Operation S230 may correspond to operation S140 of performing the training and operation S150 of generating the conversion model shown in FIG. 1. The training may be performed by using the GAN algorithm, which is a kind of AI learning algorithm. The GAN algorithm may include an adversarial generative neural network algorithm that includes a generator model and a discriminator model. A specific operation of the GAN algorithm is described in detail with reference to FIG. 3. The conversion model may be generated by the training based on the GAN algorithm.

Then, the image A may be converted into a converted image B by using the conversion model (S240). Operation S240 may correspond to operation S160 of converting SEM images into the converted design image and operation S170 of filtering the noise shown in FIG. 1. Herein, the image A may correspond to the SEM images. In addition, the converted image B may be an image that is converted from the SEM images by the conversion model and may have the same or similar file format as the image B. In addition, the converted image B may have a form of the design image corresponding to the SEM image, i.e., the image B. However, as described above, when the SEM equipment may have the measurement error, the converted image B and the image B may not match accurately in positions. In addition, the image A and the converted image B may be images on which the noise filtering is performed.

Then, the converted image B and the image B may be compared and aligned with each other (S250). Operation S250 may correspond to operation S180 of extracting the alignment coordinate values shown in FIG. 1. Herein, the comparison may correspond to a process of comparing a specific converted image B with a plurality of images B and extracting a corresponding image B. In addition, the alignment may correspond to a process of moving the converted image B in such a way that the converted image B overlaps the corresponding image B. For example, the alignment may refer to the process of moving the converted image B by x displacement (Ax) in the x-axis and y displacement (Ay) in the y-axis until the converted image B overlaps the corresponding image B. Thus, the moving distance of the converted image B in the x-axis, that is, the x displacement (Ax) and the moving distance of the converted image B in the y-axis, that is, the y displacement (Ay) in the alignment process may be determined as the alignment coordinate value. Thereafter, the measurement error of the SEM equipment may be determined by comparing the alignment coordinate value with the preset allowable value.

In operation S250 of comparing and aligning the converted image B and the image B in FIG. 2, the converted image B is shown to be smaller than the image B. This may be because the SEM image is generally obtained to be smaller than the design image and the converted design image, i.e., the converted image B is generated correspondingly to the SEM image. Accordingly, a plurality of converted images B may be generated in correspondence to a single design image, that is, the image B. In addition, the image B may include various patterns corresponding to a plurality of converted image B at different positions. However, the position of the converted image B in the image B may be different from an actual position of the converted image B, which is actually generated, due to the measurement error of the SEM equipment. In some embodiments, a single converted image B may be generated in correspondence to a single design image, i.e., a single image B.

FIG. 3 is a conceptual view illustrating a process of generating a conversion model by using a GAN algorithm in the SEM equipment alignment method shown in FIG. 1.

Referring to FIG. 3, the GAN algorithm may be a deep learning-based generative algorithm and may include two sub-models. That is, the GAN algorithm may include a generator model and a discriminator model. The generator model may generate new examples, and the discriminator model may determine whether the example is a real data, or a fake data generated by the generator model.

For example, the generator model may convert the real image to generate a converted design image, and the converted design image may be compared with a real design image and determined whether the converted design image is a real design image or a fake design image that is generated from the generator model. Specifically, in FIG. 3, when a real pattern image RPI indicating actual patterns on the semiconductor substrate is input into the generator model, the generator model may generate a converted design image CDI (S142). In addition, when the converted design image CDI and the real design image RDI are input into the discriminator model, the discriminator model determines whether the converted design image CDI is the same as or different from the real design image RDI, that is, whether the converted design image CDI is a real design image or a fake design image (S144). Thereafter, the generator model and the discriminator model may be continuously updated according to the determination result (S146). When the discriminator model reaches such a level that the converted design image CDI and the real design image RDI are not distinguished any more by repeating operations S142, S144 and S146 described above, the training may be over and the generator model may be adopted as the final generation model or the conversion model. The discriminator model may be discarded when the training is over.

To better understand the operation of the GAN algorithm, the generator model is assumed to be a counterfeiter and the discriminator model is assumed to be a policeman. Thus, the counterfeiter is set to make fake money that is not distinguished from real money, and the policeman is set to distinguish real money from fake money well. Therefore, the counterfeiter and the policeman compete and in terms of game theory, they are adversarial and have effects on each other as if they played a zero-sum game. In other words, when the policeman successfully distinguishes between fake money and real money, the policeman does not need to update the parameters for the distinction. In contrast, the counterfeiter needs to update many parameters for forgery. However, when the counterfeiter successfully makes fake money and the policeman cannot distinguish between fake money and real money, the counterfeiter does not need to update the parameters for forgery. In contrast, the policeman needs to update many parameters for distinction. When the processes described above continues to be repeated, the forgery may reach such a level that the policeman cannot distinguish between fake money and real money, and the forgery method may be a final generation model or a final conversion model.

FIG. 4 is a flowchart showing a method of filtering a converted design image in the SEM equipment alignment method in FIG. 1.

Referring to FIG. 4, at first, the converted design image may be quantized (S171). The converted design image may be digitized for each pixel. For example, the converted design image may be converted to a gray level scale. Accordingly, a number may be allocated to each pixel in the image.

Thereafter, a gray level co-occurrence matrix (GLCM) may be calculated for the quantized converted design image (S173). The GLCM may include information on a spatial relationship between a pair of pixels of the image. That is, the GLCM may be used to classify and identify the objects of the image and to distinguish various types of textures. The texture may be one of the characteristics used for identifying an interesting area or objects in the image.

Thereafter, statistical characteristics of the GLCM may be extracted (S175). For example, the statistical characteristics, such as contrast, homogeneity, entropy, energy, correlation, dissimilarity, standard deviation, mean, and/or variance, may be calculated by analyzing the GLCM.

The contrast may indicate a local change of the GLMC. For example, the contrast may be an intensity difference between neighboring pixels in the image. In contrast, the homogeneity may indicate an intensity similarity between neighboring pixels in the image. The entropy may indicate randomness or complexity of the texture. The higher the entropy, the higher the complexity of the image texture, and the lower the entropy, the more uniform and repetitive the texture may be. The energy may indicate uniformity of the texture. The correlation may indicate linear dependency between a pair of pixels of the image, and the dissimilarity may indicate intensity differences between neighboring pixels.

Thereafter, an image may be filtered by the extracted statistical characteristics (S177). For example, when the statistical characteristics extracted in operation S175 are out of a preset reference range, the image may be filtered as the noise. The alignment coordinate value of the filtered image may be extracted (S180) and the measurement error of the SEM equipment may be determined (S190).

In FIGS. 1 and 4, operation S170 of filtering the noise is performed before or prior to operation S180 of extracting the alignment coordinate value and operation S190 of determining the measurement error of the SEM equipment, but the inventive concept is not limited thereto. For example, operation S170 of filtering the noise may be performed after operation S180 of extracting the alignment coordinate value or after operation S190 of determining the measurement error of the SEM equipment.

According to the conventional noise filtering method, the score is calculated by using pre-registered images and measured images, and all images are stored even though the score is low. However, since when the difference between the pre-registered image and the measured image is large, the mismeasured image and the normally measured image may not be distinguished by the score, there are limitations for filtering noise in the conventional noise filtering method.

In contrast, the noise filtering method according to an embodiment may quickly and accurately detect noise by filtering the converted design image. The noise filtering method of the inventive concept may convert the converted design image into the GLCM and may quickly and accurately detect the noise by extracting the statistical characteristics of the GLCM.

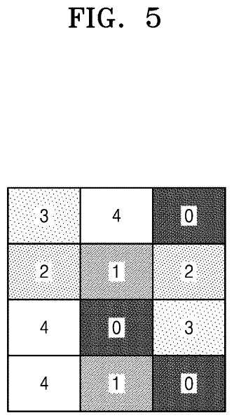

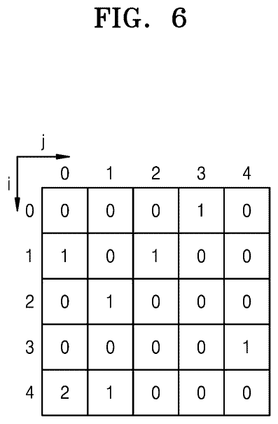

FIG. 5 is a conceptual view illustrating a quantized converted design image according to some embodiments, and FIG. 6 is a conceptual view illustrating the GLCM corresponding to the image shown in FIG. 5. The descriptions are given with reference to FIGS. 5 and 6 together with FIG. 4.

Referring to FIG. 5, the converted design image may include a plurality of pixels in a form of 4×3 matrix. The pixels of the converted design image may be modified to have various forms of the matrix. For example, the converted design image may be converted to a gray level scale. Accordingly, a number may be individually allocated to each pixel of the image. For example, numbers of 0 to 4 may be allocated to each pixel. For example, 0 to 4 may correspond to a red, green, and blue (RGB) value or luminosity of each pixel. For example, level 0 may correspond to lowermost luminosity and level 4 may correspond to uppermost luminosity.

An average value, an intermediate value, a root-mean-square (RMS) value, a minimal value, and/or a maximal value of the RGB value or luminosity of each pixel may be converted into a number. The range of the gray level scale may be variously modified, as would be known to a person of ordinary skill in the art. For example, the converted design image may be converted to the gray level scales of 2 levels, 4 levels, 16 levels, and/or 256 levels.

Referring to FIG. 6, the converted design image in FIG. 5 may be converted into the GLCM. Since the converted design image in FIG. 5 has five levels with numbers from 0 to 4, the number of rows and columns in the GLCM may be five, respectively. For example, the converted design image may be converted to the gray level scale having 5 levels. That is, the GLCM in FIG. 6 may be provided in a form of 5×5 matrix.

Thereafter, in the same row of the converted design image in FIG. 5, the numbers of neighboring two pixels may be paired in order. For example, the numbers (3,4) and (4,0) may be combined in the neighboring two pixels of the uppermost row in FIG. 5. By repeating the process from rows 1 to 4, the frequency of each combination may be calculated.

The frequency of the combinations may correspond to the value of each component of the GLCM, respectively. For example, when (i,j) appears n_{i,j} times in the inferred image, the (i,j) component of the GLCM may be determined as n_{i,j}.

By the process described above, the converted design image in FIG. 5 may be converted into the GLCM in FIG. 6. Although not shown in FIG. 6, each component of the GLCM may be divided by the sum of all components of the GLCM, to thereby normalize the GLCM.

Thereafter, the statistical characteristics of the GLCM may be calculated. For example, the entropy of the GLCM may be calculated as follows.

As described above, the entropy may indicate the randomness or the complexity of the texture in the GLCM. The higher the entropy, the higher the randomness of the texture, and the lower the entropy, the lower the randomness of the texture. The entropy may be calculated by the following equation.

$$Entropy = {\sum }_{i , j = 0}^{N - 1} {P}_{i , j} ( - ln {P}_{i , j} ) \qquad [ Equation ]$$

In the entropy equation, P_{i,j} denotes a normalized value of an (i,j) component of the GLCM, and N denotes the number of levels of a gray level scale.

For example, when the entropy of the converted design image is greater than or equal to a reference value, the converted design image may be determined as noise. In addition, the SEM image corresponding to the converted design image may also be determined as noise. For example, the reference value may be 4.

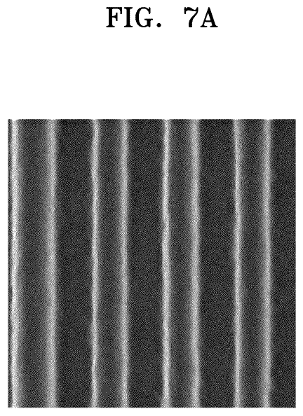

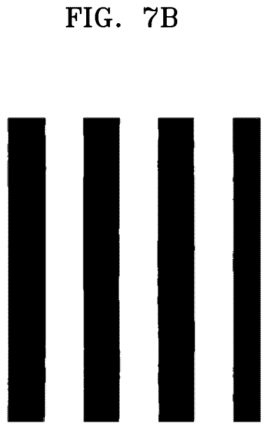

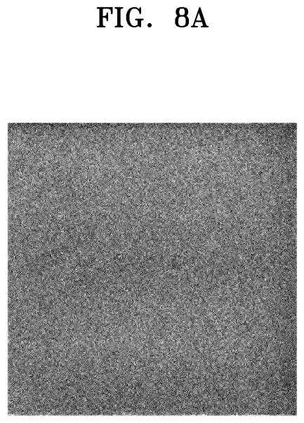

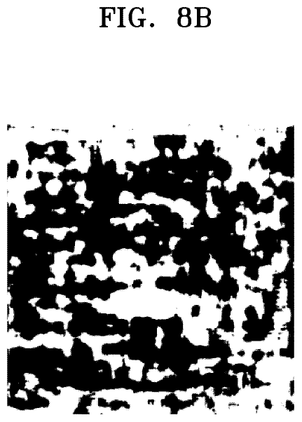

FIG. 7A is an SEM image that is not determined as noise according to some embodiments, and FIG. 7B is a converted design image generated by converting the SEM image in FIG. 7A. FIG. 8A is an SEM image that is determined as noise according to some embodiments, and FIG. 8B is a converted design image generated by converting the SEM image in FIG. 8A.

Referring to FIGS. 7A to 8B, the pattern of the SEM image that is not determined as the noise is relatively clear, and the pattern of the SEM image that is determined as the noise may be relatively unclear. In addition, the pattern of the converted design image corresponding to the SEM image that is not determined as the noise is clearly shown, and the pattern of the converted design image corresponding to the SEM image that is determined as the noise is not easily observed. Accordingly, whether a particular SEM image includes noise or not may be easily determined by the comparison between the converted design images.

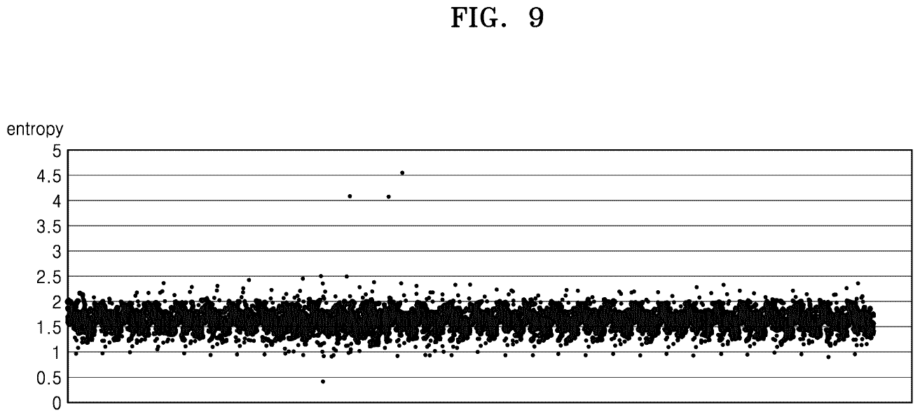

FIG. 9 is a graph showing an entropy distribution of a plurality of converted design images according to some embodiments. The descriptions are given with reference to FIG. 9 together with FIGS. 5 and 6. In the graph in FIG. 9, the vertical axis indicate entropy.

Referring to FIG. 9, most of the GLCMs of the converted design images may have an entropy in a range of about 0.5 to about 2.5. In addition, a few GLCM may have an entropy greater than about 4. For example, the converted design images having an entropy greater than about 4 may be determined as noise images. The noise images may be filtered and removed.

FIG. 10A is a block diagram showing an alignment apparatus of SEM equipment according to some embodiments, and FIG. 10B is a block diagram showing a calculation server of the alignment apparatus of the SEM equipment in FIG. 10A in more detail. In FIGS. 10A and 10B, the descriptions on the same elements in FIGS. 1 to 9 may be briefly given or omitted in the interest of brevity.

Referring to FIGS. 10A and 10B, the alignment apparatus 100 of the SEM equipment according to an embodiment may include a SEM measurement device 110, an SEM server or SEM controller 130, and a calculation and alignment server or calculation and alignment controller 150.

The SEM measurement device 110 may refer to an apparatus for photographing patterns on the semiconductor substrate as the SEM image. The SEM measurement device 110 may include an electron gun, an anode, a magnetic lens, a scanning coil, a first detector, a second detector, a scanner, and a stage. The electron gun may include, for example, a Schottky type or a thermoelectric emission type electron gun. The electron beams may be emitted by applying an acceleration voltage to the electron gun. The anode may include an acceleration electrode, and the electron beam may be accelerated by a voltage applied between the electron gun and the anode. The magnetic lens may focus and accelerate the electron beam. The scanning coil may scan the electron beam one-dimensionally or two-dimensionally on the semiconductor substrate that is a specimen to be measured. The first detector may detect backward scattered electrons (BSE) that are emitted from the semiconductor substrate by the electron beam irradiation, and the second detector may detect secondary electrons (SE) that are generated from the semiconductor substrate by the electron beam irradiation. The scanner may analyze detection signals for the electrons that are detected from the first and second detectors and may generate an image of the patterns on the semiconductor substrate, that is, the SEM image. The stage may be a device on which the semiconductor substrate is located, and thus, the semiconductor substrate may be positioned on an upper surface of the stage and supported by the stage and may move along with the movement of the stage.

The SEM server 130 may control all operations of the SEM measurement device 110 and transfer the SEM image, which is obtained from the SEM measurement device 110, and various data related to the measurement of the SEM image to the calculation and alignment server 150. For example, the data related to the measurement of the SEM image may include data on measurement coordinates, field of view (FOV), pixel size, rotation, etc. The SEM image may be obtained by the SEM measurement device 110 based on the measurement coordinates stored in the SEM server 130. When there is an error in the measurement coordinates stored in the SEM server 130, the SEM image obtained by the SEM measurement device 110 may include a position error, and thus, the SEM image may deviate from the corresponding design image. Therefore, the SEM measurement device 110 or the SEM equipment may be aligned by correcting the measurement coordinates in the SEM server 130, so that the SEM measurement device 110 may obtain the SEM image at the correct measurement coordinates.

The calculation and alignment server 150 may perform various operations, such as the pre-processing on the design images corresponding to the SEM images, the selection of the training SEM images, the training by using the GAN algorithm to thereby generate conversion models, the generation of the converted design images, the extraction of the alignment coordinate values by comparison and alignment, and the classification of the noise images. After being extracted, the alignment coordinate values may be fed back to the SEM server 130, and thus, the measurement coordinates in the SEM server 130 may be corrected.

Referring to FIG. 10B, the calculation and alignment server 150 may include a pre-processor 152, a conversion model generator 154 based on artificial intelligence (AI), a noise filter 155, an alignment coordinate value extractor 156, and an error checker 158. The pre-processor 152 may perform a pre-processing on the SEM images and the design images corresponding to the SEM images. The pre-processing on the SEM images may include, for example, generation of a measurement information file. The pre-processing on the design images may include, for example, conversion of a file format. The AI-based conversion model generator 154 may select the training SEM images and the actual training images corresponding to the training SEM images and perform the training by using the GAN algorithm. In addition, the conversion model may be generated as a result of the training. The noise filter 155 may quantize the converted design image, convert the quantized converted design image into the GLCM, and calculate the statistical characteristics of the GLCM. For example, the noise filter 155 may filter the noise by calculating the entropy of the GLCM.

The alignment coordinate value extractor 156 may convert the SEM images into the converted design images by using the conversion model. In addition, the converted design images may be compared and aligned with the corresponding design images to extract the alignment coordinate value. The error checker 158 may check the measurement error of the SEM equipment by comparing the extracted alignment coordinate value with the preset allowable value. In addition, when checking that the measurement error is in the SEM equipment, the error checker 158 may feedback the alignment coordinate value to the SEM server 130.

Until now, the inventive concept has been described with reference to the embodiments illustrated in the drawings, but these are only examples, and those of ordinary skill in the art will understand that various modifications and equivalent other embodiments are obtainable therefrom. Therefore, the true technical scope of protection of the disclosure should be determined by the technical idea of the appended claims.

While the inventive concept has been particularly shown and described with reference to embodiments thereof, it will be understood that various changes in form and details may be made therein without departing from the scope of the following claims.

What is claimed is:

1. A noise filtering method comprising:
converting a scanning electron microscope (SEM) image into a converted design image using a conversion model;
converting the converted design image into a gray level co-occurrence matrix (GLCM);
extracting statistical characteristics of the GLCM; and
determining whether the converted design image includes noise or not, based on the statistical characteristics.

2. The noise filtering method of claim 1, further comprising:
quantizing the converted design image.

3. The noise filtering method of claim 2, wherein
each pixel of the converted design image is converted into a number corresponding to one of a red, green, and blue (RGB) value and luminosity.

4. The noise filtering method of claim 3, wherein
each pixel of the converted design image is converted into the number based on at least any one of an average value, an intermediate value, a root-mean-square (RMS) value, a minimal value, and a maximal value of one of the RGB value and the luminosity.

5. The noise filtering method of claim 1, wherein
the statistical characteristics include at least one of a contrast, a homogeneity, an entropy, an energy, a correlation, a dissimilarity, a standard deviation, a mean, and a variance.

6. The noise filtering method of claim 1, wherein
the determining whether the converted design image includes noise or not includes
when the statistical characteristics are out of a preset reference range, determining the converted design image includes noise.

7. The noise filtering method of claim 1, wherein
when the converted design image is determined as including noise, the SEM image corresponding to the converted design image is determined as the noise.

8. The noise filtering method of claim 1, wherein
the conversion model uses a generative adversarial network (GAN) algorithm.

9. A noise filtering method comprising:
obtaining SEM images of a target to be measured by using SEM equipment;
performing a pre-processing on the SEM images and design images corresponding to the SEM images;
selecting training SEM images for training from among the SEM images;
performing training by using the training SEM images and training design images corresponding to the training SEM images, to generate a conversion model between the SEM images and the design images;
converting the SEM images into converted design images by using the conversion model;
converting each converted design image into a gray level co-occurrence matrix (GLCM);
extracting statistical characteristics of the GLCM; and
determining whether or not the converted design images include noise based on the statistical characteristics.

10. The noise filtering method of claim 9, wherein
the determining whether or not the converted design images include noise is performed by calculating an entropy of the GLCM.

11. The noise filtering method of claim 10, wherein
the entropy is calculated by a following equation:
$$Entropy = {\sum }_{i , j = 0}^{N - 1} {P}_{i , j} ( - ln {P}_{i , j} ) \qquad [ Equation ]$$
wherein P_{i,j} denotes a normalized value of an (i,j) component of the GLCM, and N denotes a number of levels of a gray level scale.

12. The noise filtering method of claim 9, wherein,
in generating the conversion model,
the conversion model is generated by using a generative adversarial network (GAN) algorithm including a generator model and a discriminator model,
the generator model is configured to generate an initial converted design image for each training SEM image,
the discriminator model is configured to compare the initial converted design image with the corresponding design image and determine whether the initial converted design image is real or fake, and
the generator model and the discriminator model are each complementarily fed back to generate the conversion model.

13. The noise filtering method of claim 9, wherein
in the performing the pre-processing,
a measurement information file is generated for the SEM images, and the design images are converted into bitmap images in a bitmap file format.

14. The noise filtering method of claim 9, wherein
the design images include computer-aided design (CAD) images in a graphical data system (GDS) format.

15. A scanning electron microscope (SEM) equipment alignment method comprising:
obtaining a plurality of SEM images for a target by using SEM equipment;
performing pre-processing on the SEM images and corresponding design images;
selecting training SEM images for training from among the SEM images;
performing training based on the training SEM images and training design images corresponding to the training SEM images, to generate a conversion model between the SEM images and the design images;
converting the SEM images into converted design images by using the conversion model;
converting each converted design image into a gray level co-occurrence matrix (GLCM);
extracting statistical characteristics of the GLCM;
determining whether the converted design images include noise based on the statistical characteristics;
comparing and aligning each converted design image with the corresponding design image,
to extract an alignment coordinate value; and
determining a measurement error of the SEM equipment based on the alignment coordinate value.

16. The SEM equipment alignment method of claim 15, wherein
each pixel of the converted design image is converted into a gray level scale based on at least any one of an average value, an intermediate value, a root-mean-square (RMS) value, a minimal value, and a maximal value of one of a red, green, and blue (RGB) value and luminosity.

17. The SEM equipment alignment method of claim 16, wherein
a number of rows and a number of columns of the GLCM correspond to a number of levels of the gray level scale.

18. The SEM equipment alignment method of claim 15, wherein
when an entropy of the GLCM is greater than or equal to 4, the converted design image corresponding to the GLCM is determined as the noise.

19. The SEM equipment alignment method of claim 15, wherein
when the converted design image is determined as the noise, the SEM image corresponding to the converted design image is determined as the noise.

20. The SEM equipment alignment method of claim 15, wherein,
in the performing pre-processing,
the design images include a computer-aided design (CAD) images in a graphical data system (GDS) format,
a measurement information file is generated for the SEM images, and the design images are converted into bitmap images in a bitmap file format.
